(19) United States
(12) Patent Application Publication
(10) Pub. No.: US 2021/0262282 A1
(43) Pub. Date: Aug. 26, 2021

(54) POWER-ASSISTED PULLING DEVICE FOR ROLLER SHUTTER COVER

(71) Applicant: Foshan Bestwyll Auto Accessories Co., Ltd, Foshan (CN)

(72) Inventor: Yong Xia, Foshan (CN)

(73) Assignee: Foshan Bestwyll Auto Accessories Co., Ltd.

(21) Appl. No.: 17/231,017

(22) Filed: Apr. 15, 2021

(30) Foreign Application Priority Data
Feb. 3, 2021 (CN) 202120313658.3

(51) Int. Cl. E06B 9/17; E06B 9/68

(52) U.S. Cl. CPC E06B 9/17061; E06B 9/68; E06B 9/17007

(57) ABSTRACT

The present disclosure discloses a power-assisted pulling device for a roller shutter cover. The device includes a canister. The top of the canister is fixedly connected with guide rails, and inner cavities of the guide rails are movably connected with a roller shutter. The present disclosure has the advantages that roller shutter leaves are rolled up smoothly and the roller shutter can be completely collected, and solves the following problem.

### TECHNICAL FIELD

The present disclosure relates to the technical field of roller shutters, specifically to a power-assisted pulling device for a roller shutter cover.

### BACKGROUND

In the use process of an existing power-assisted pulling device for a roller shutter cover, a torsional spring method is usually used to pull and roll up roller shutter leaves. During pulling with this method, the power of a torsional spring and the power of a motor cannot be synchronized, and have a conflict with each other. When pushing the roller shutter leaves to move outwards, the motor needs to overcome the force of the torsional spring itself, so that the power loss is relatively high. Moreover, in order to connect the roller shutter leaves to the torsional spring, several roller shutter leaves need to be added for connection, causing that the several additional roller shutter leaves will additionally occupy the volume of a roller shutter leaf canister, and resulting in a larger volume of the roller shutter leaf canister, thereby reducing the applicability of the pulling device.

### SUMMARY

The present disclosure is directed to provide a power-assisted pulling device for a roller shutter cover, which has the advantages that roller shutter leaves are rolled up smoothly and a roller shutter can be completely collected, and solves the following problem. In the use process of an existing power-assisted pulling device for a roller shutter cover, a torsional spring method is usually used to pull and roll up roller shutter leaves; during pulling with this method, the power of a torsional spring and the power of a motor cannot be synchronized, and have conflict with each other; when pushing the roller shutter leaves to move outwards, the motor needs to overcome the force of the torsional spring itself, so that the power loss is relatively high; and moreover, in order to connect the roller shutter leaves to the torsional spring, several roller shutter leaves need to be added for connection, causing that the several additional roller shutter leaves will additionally occupy the volume of a roller shutter leaf canister and resulting in a larger volume of the roller shutter leaf canister, thereby reducing the applicability of the pulling device.

In order to achieve the above-mentioned objective, the present disclosure provides the following technical solution: a power-assisted pulling device for a roller shutter cover, including a canister. The top of the canister is movably connected with a roller shutter; the rear side of an inner cavity of the canister is fixedly connected with a containing disc; a spiral orbit is fixedly arranged on a side surface of the containing disc; the side surface of the containing disc is provided with a bolt in a penetrating manner, and the bolt is in threaded connection with the containing disc; the surface of the bolt is sleeved with a containing spring; a hanging hole matching the containing spring is formed in a side end of the top of the roller shutter; a top end of the containing spring runs through the hanging hole; a servo motor is fixed on one side of the inner cavity of the canister; a rotating shaft of the servo motor is fixedly connected with a driving gear; and the driving gear meshes the roller shutter.

Preferably, two sides of the roller shutter are respectively embedded into guide rails and are slidably connected with the guide rails, and the two guide rails are fixedly connected with the canister.

Preferably, the width of the spiral orbit is the same as the thickness of the roller shutter.

Preferably, the bolt is arranged in the center of the spiral orbit.

Preferably, the left sides of the guide rails are fixedly connected with limiting plates, and the left side of the roller shutter is in contact with the limiting plates.

Preferably, a plurality of mounting holes are formed in the front side of the containing disc.

Preferably, the top of the rear side of the inner cavity of the canister is fixedly connected with a first guide plate, and the first guide plate is located at the top of the containing disc.

Preferably, the bottom of the left side of the canister is fixedly connected with a second guide plate, and the second guide plate is located at the bottom of the containing disc.

Compared with the prior art, the present disclosure has the beneficial effects as follows:

1. By cooperation of the canister, the guide rails, the roller shutter, the containing disc, the spiral orbit, the bolt, the containing spring, the hanging hole, the servo motor and the driving gear, the present disclosure has the advantages that roller shutter leaves are rolled up smoothly and a roller shutter can be completely collected, and solves the following problem. In the use process of an existing power-assisted pulling device for a roller shutter cover, a torsional spring method is usually used to pull and roll up roller shutter leaves; during pulling with this method, the power of a torsional spring and the power of a motor cannot be synchronized, and have conflict with each other; when pushing the roller shutter leaves to move outwards, the motor needs to overcome the force of the torsional spring itself, so that the power loss is relatively high; and moreover, in order to connect the roller shutter leaves to the torsional spring, several roller shutter leaves need to be added for connection, causing that the several additional roller shutter leaves will additionally occupy the volume of a roller shutter leaf canister and resulting in a larger volume of the roller shutter leaf canister, thereby reducing the applicability of the pulling device.

2. By the arrangement of the guide rails, the present disclosure can guide the roller shutter to avoid a skewing phenomenon; by the arrangement of the containing disc and the spiral orbit, the roller shutter is convenient to roll up; by the arrangement of the bolt, the containing spring can be stably supported and fixed; by the arrangement of the containing spring and the hanging hole, the roller shutter can be pulled in the roll-up process, so that the roller shutter can be completely collected to the inner cavity of the canister; and by the arrangement of the servo motor and the driving gear, the roller shutter can be driven to be rolled up.

### BRIEF DESCRIPTION OF THE DRAWINGS

FIG. 1 is a schematic front view of a structure of the present disclosure;

FIG. 2 is a schematic sectional view of a local structure of the present disclosure;

FIG. 3 is an enlarged view of A of the structure in FIG. 1 of the present disclosure;

FIG. 4 is an enlarged view of B of the structure in FIG. 2 of the present disclosure.

In the drawings: 1: canister; 2: guide rail; 3: roller shutter; 4: containing disc; 5: spiral orbit; 6: bolt; 7: containing spring; 8: hanging hole; 9: servo motor; 10: driving gear; 11: limiting plate; 12: mounting hole; 13: first guide plate; 14: second guide plate.

### DESCRIPTION OF THE EMBODIMENTS

The technical solutions in the embodiments of the utility model will be described clearly and completely below with reference to the drawings in the embodiments of the utility model. Obviously, the embodiments described herein are only part of the embodiments of the utility model, not all the embodiments. Based on the embodiments in the present disclosure, all other embodiments obtained by those of ordinary skill in the art without creative work shall fall within the protection scope of the present disclosure.

In the description of the present disclosure, it should be noted that orientations or positional relationships indicated by the terms “upper”, “lower”, “inside”, “outside”, “front end”, “rear end”, “two ends”, “one end”, “the other end” and the like are orientations or positional relationships as shown in the drawings, and are only for the purpose of facilitating and simplifying the description of the present disclosure instead of indicating or implying that devices or elements indicated must, have particular orientations, and be constructed and operated in the particular orientations, so that these terms are construed as limiting the present disclosure. In addition, the terms “first” and “second” are only for the purpose of description, and may not be understood as indicating or implying the relative importance.

In the description of the present disclosure, it should be noted that unless otherwise explicitly specified and defined, the terms “installed”, “provided with” and “connected” shall be understood broadly. For example, “connected” may be fixedly connected, or detachably connected, or integrally connected, or mechanically connected, or electrically connected, or directly connected, or indirectly connected through an intermediate medium, or interconnection between two elements. Those of ordinary skill in the art can understand the specific meanings of the above terms in the present disclosure according to specific situations.

A canister 1, guide rails 2, a roller shutter 3, a containing disc 4, a spiral orbit 5, a bolt 6, a containing spring 7, a hanging hole 8, a servo motor 9, a driving gear 10, limiting plates 11, mounting holes 12, a first guide plate 13 and a second guide plate 14 of the present disclosure are all general standard parts or parts known to those skilled in the art, the structures and principles of which are all obtained by those skilled in the art through technical manuals or obtained through conventional experimental methods.

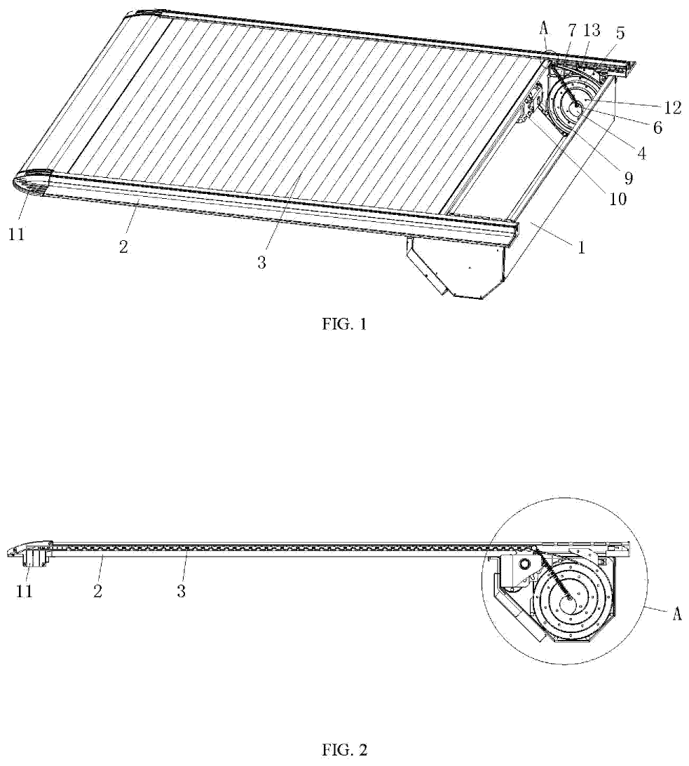

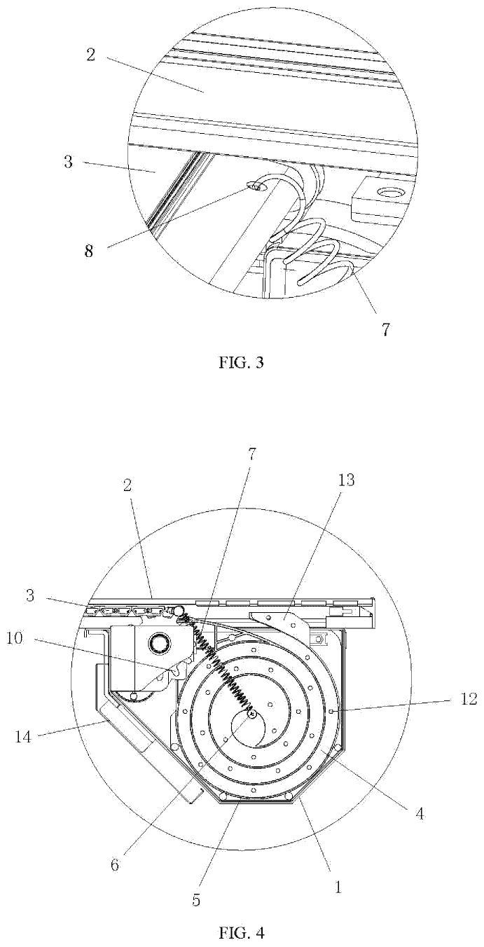

Referring to FIGS. 1 to 4, a power-assisted pulling device for a roller shutter cover includes the canister 1. The top of the rear side of an inner cavity of the canister 1 is movably connected with the first guide plate 13; the first guide plate 13 is located at the top of the containing disc 4; the bottom of the left side of the canister 1 is fixedly connected with the second guide plate 14; the second guide plate 14 is located at the bottom of the containing disc 4; and the top of the canister 1 is fixedly connected with guide rails 2. By the arrangement of the guide rails 2, the roller shutter 3 can be guided to avoid a skewing phenomenon. The left sides of the guide rails 2 are fixedly connected with limiting, plates 11, and the left side of the roller shutter 3 is in contact with the limiting plates 11. Inner cavities of the guide rails 2 are movably connected with the roller shutter 3. The rear side of the inner cavity of the canister 1 is fixedly connected with the containing disc 4. A plurality of mounting holes 12 are formed in the front side of the containing disc 4. The front side of the containing disc 4 is provided with the spiral orbit 5 matching the roller shutter 3. By the arrangement of the containing disc 4 and the spiral orbit 5, the roller shutter 3 is convenient to roll up. The front side of the containing disc 4 is provided with the bolt 6 in a penetrating manner. By the arrangement of the bolt 6, the containing spring 7 can be stably supported and fixed. The rear end of the bolt 6 is in threaded connection with the containing disc 4. The surface of the bolt 6 is sleeved with the containing spring 7. The hanging hole 8 matching the containing spring 7 is formed in the right, side of the top of the roller shutter 3. The top end of the containing spring 7 runs through the hanging hole 8. By the arrangement of the containing spring 7 and the hanging hole 8, the roller shutter 3 can be pulled in the roll-up process, so that the roller shutter can be completely collected to the inner cavity of the canister 1. The left side of the rear side of the inner cavity of the canister 1 is fixedly connected with the servo motor 9, and a rotating shaft of the servo motor 9 is fixedly connected with a driving gear 10 matching the roller shutter 3. By the arrangement of the servo motor 9 and the driving gear 10, the roller shutter 3 can be driven to be rolled up. By cooperation of the canister 1, the guide rails 2, the roller shutter 3, the containing disc 4, the spiral orbit 5, the bolt 6, the containing spring 7, the hanging hole 8, the servo motor 9 and the driving gear 10, the present disclosure has the advantages that roller shutter leaves are rolled up smoothly and the roller shutter can be completely collected, and solves the following, problem. In the use process of an existing power-assisted pulling device for a roller shutter cover, a torsional spring method is usually used to pull and roll up roller shutter leaves; during pulling with this method, the power of a torsional spring and the power of a motor cannot be synchronized, and have conflict with each other; when pushing the roller shutter leaves to move outwards, the motor needs to overcome the force of the torsional spring itself, so that the power loss is relatively high; and moreover, in order to connect the roller shutter leaves to the torsional spring, several roller shutter leaves need to be added for connection, causing that the several additional roller shutter leaves will additionally occupy the volume of a roller shutter leaf canister and resulting in a larger volume of the roller shutter leaf canister, thereby reducing the applicability of the pulling device.

During use, the canister 1 is mounted at a proper position. When the roller shutter 3 needs to be rolled up and collected, an external controller controls the servo motor 9 to run; the rotating shaft of the servo motor 9 drives the driving gear 10 to rotate; the driving gear 10 drives the roller shutter 3 to move; the roller shutter 3 starts to move to the inner cavity of the canister 1; under the action of a tensile force of the containing spring 7, the roller shutter 3 starts to be wound on the surface of the containing disc 4 through the spiral orbit 5; the roller shutter 3 slides in the spiral orbit 5 from the biggest circle to the smallest circle; circles become smaller and smaller; when the roller shutter 3 is at the biggest circle, the containing spring 7 is in a stressed state and will pull the roller shutter 3 to move to the center; and when the roller shutter 3 slides to the smallest circle, the containing spring 7 will shorten as the circle becomes small, so as to completely collect the roller shutter 3.

According to the above, by cooperation of the canister 1, the guide rails 2, the roller shutter 3, the containing disc 4, the spiral orbit 5, the bolt 6, the containing spring 7, the hanging hole 8, the servo motor 9 and the driving gear 10, the power-assisted pulling device solves the following problem. In the use process of an existing power-assisted pulling device for a roller shutter cover, a torsional spring method is usually used to pull and roll up roller shutter leaves; during pulling with this method, the power of a torsional spring and the power of a motor cannot be synchronized, and have conflict with each other; when pushing the roller shutter leaves to move outwards, the motor needs to overcome the force of the torsional spring itself, so that the power loss is relatively high; and moreover, in order to connect the roller shutter leaves to the torsional spring, several roller shutter leaves need to be added for connection, causing that the several additional roller shutter leaves will additionally occupy the volume of a roller shutter leaf canister and resulting in a larger volume of the roller shutter leaf canister, thereby reducing the applicability of the pulling device.

Although the embodiments of the present disclosure have been shown and described, it will be understood by those of ordinary skill in the art that various changes, modifications, substitutions, and transformations can be made to these embodiments without departing from the principle and spirit of the utility model. The scope of the present disclosure is defined by the attached claims and their equivalents.

1. A power-assisted pulling device for a roller shutter cover, comprising a canister (1), wherein the top of the canister (1) is movably connected with a roller shutter (3); the rear side of an inner cavity of the canister (1) is fixedly connected with a containing disc (4); a spiral orbit (5) is fixedly arranged on a side surface of the containing disc (4); the side surface of the containing disc (4) is provided with a bolt (6) in a penetrating manner, and the bolt (6) is in threaded connection with the containing disc (4); the surface of the bolt (6) is sleeved with a containing spring (7); a hanging hole (8) matching the containing spring (7) is formed in a side end of the top of the roller shutter (3); a top end of the containing spring (7) runs through the hanging hole (8); a servo motor (9) is fixed on one side of the inner cavity of the canister (1); a rotating shaft of the servo motor (9) is fixedly connected with a driving gear (10); and the driving gear (10) meshes the roller shutter (3).

2. The power-assisted pulling device for the roller shutter cover according to claim 1, wherein two sides of the roller shutter (3) are respectively embedded into guide rails (2) and are slidably connected with the guide rails (2), and the two guide rails (2) are, fixedly connected with the canister (1).

3. The power-assisted pulling device for the roller shutter cover according to claim 1, wherein the width of the spiral orbit (5) is the same as the thickness of the roller shutter (3).

4. The power-assisted pulling device for the roller shutter cover according to claim 1, wherein the bolt (6) is arranged in the center of the spiral orbit (5).

5. The power-assisted pulling device for the roller shutter cover according to claim 1, wherein the left sides of the guide rails (2) are fixedly connected with limiting plates (11), and the left side of the roller shutter (3) is in contact with the limiting plates (11).

6. The power-assisted pulling device for the roller shutter cover according to claim 1, wherein a plurality of mounting holes (12) are formed in the front side of the containing disc (4).

7. The power-assisted pulling device for the roller shutter cover according to claim 1, wherein the top of the rear side of the inner cavity of the canister (1) is fixedly connected with a first guide plate (13), and the first guide plate (13) is located at the top of the containing disc (4).

8. The power-assisted pulling device, for the roller shutter cover according to claim 1, wherein the bottom of the left side of the canister (1) is fixedly connected with a second guide plate (14), and the second guide plate (14) is located at the bottom of the containing disc (4).
